(19) United States
(12) Patent Application Publication
(10) Pub. No.: US 2012/0051387 A1
(43) Pub. Date: Mar. 1, 2012

(54) System and Method for Heating Material Samples

(76) Inventors: Marc Boivin, Wendake (CA); Alain Chantal, St. Nicolas (CA); Pierre-Emmanuel LeMay, Quebec (CA)

(21) Appl. No.: 12/868,871

(22) Filed: Aug. 26, 2010

(51) Int. Cl. H05B 3/64; F27D 11/02; H05B 3/46

(52) U.S. Cl. 373/134; 219/522

(57) ABSTRACT

A heating apparatus is disclosed, that may include a ceramic rod having at least one circumferential groove extending substantially circumferentially about a perimeter of the rod; and a coil located about the perimeter of the rod and having turns of the coil embedded with the grooves of the rod.

### BACKGROUND OF THE INVENTION

The present invention relates in general to heating systems and methods and in particular to the use of heating elements that are resilient in the face of very high temperatures and the possibility of flux or other debris being deposited near or on the heating elements.

On occasion, laboratory personnel using such devices will also add a halogen chemical compound, to facilitate the removal of the end-product. Upon heating the crucible, the lithium borate melts and dissolves the sample. This dissolution reaction is enhanced by the agitation of the crucible. After complete reaction, the resulting hot solution is poured into a plate-shaped mold and cooled, to produce a glassy disk that is then placed in an elemental analyzer.

The temperature of the crucible-heating process can reach 1200 degrees Celsius, which poses tremendous challenges to the durability of the materials and parts used. At such high temperatures, most materials will likely burn, melt, rapidly oxidize in the presence of oxygen in the air and possibly chemically interact with the halogen gases released by the heating process.

Thus, there is a need in the art for an apparatus that would durably support the crucibles and the molds and reliably heat the furnace chamber, to minimize repair operations by laboratory personnel in remote areas, while maintaining a clean environment in the furnace, and while avoiding contaminating the samples being processed.

### Crucible Holders

In existing systems, crucibles are typically held either using metallic clips (as in the case of gas fluxers from Corporation Scientifique Claisse, Canada), or placed in a shallow tube (as practiced in the electrical furnace by ModuTemp, Australia), or on horizontally running parallel ceramic rods (as offered by Katanax and Corporation Scientifique Claisse on their respective electric fluxers). In the last of the above-listed configurations, crucibles are held apart by small ceramic spacers (Katanax) or by a single scalloped metallic part (Corporation Scientifique Claisse).

Crucible holders are typically designed to enable repair or replacement to be as easy and as fast as possible. The ease and speed of replacement are needed because flux tends to spill onto the holder, and cleaning must be performed quickly in a production setting to avoid costly downtime.

### Mold Holders

Molds can be secured with metallic clips (as offered on gas fluxers by Corporation Scientific Claisse, Canada), or the mold may rest on a metal plate with circular openings. Both the mold and the crucible holder may increase thermal expansion of their respective lengths in the range of 3 to 8 mm (millimeters). If compliance is not built into the surrounding parts to accept this expansion, the heat-exposed parts will be longitudinally compressed between their fastening points (located outside the furnace), and are likely to sag and fail.

### Heating Elements

The only heating elements that are known to reach temperatures suitable for resistive heating fusion machines are: SiC—Silicon carbide. One drawback of SiC is ageing. Due to heat exposure, each heating element's electrical characteristics will change over time, making it nearly impossible to replace a single element in a multi-element configuration. Doing so would strongly reduce the life expectancy of the heating elements that are not being replaced.

MoSi2—molybdenum disilicide is another element commonly used for heating elements. The main challenge encountered when designing with MoSi2 is that it sags heavily at high temperature, and becomes very brittle upon cooling. The heating element is typically installed in a U-shaped free-hanging configuration. Molybdenum disilicide is known to potentially react with halogens, and degrade prematurely.

### FECRAL—Iron-Chromium-Aluminum Metallic Alloy:

The effects incurred at high temperatures cause the drawback of this alloy. At high temperatures, FeCrAl becomes soft, and coil-shaped elements will deform to the point that the turns of the helically wound resistive heating coil tend to approach one another, leading to element failure by localized overheating. This type of element can also experience surface reaction with halogen gases or flux spills, and then fail rapidly.

Accordingly, there is a need in the art for improved configurations of heating elements and associated parts of resistive-heating furnaces.

### SUMMARY OF THE INVENTION

According to one aspect, the invention is direct to a heating apparatus that may include a ceramic rod having at least one circumferential groove extending substantially circumferentially about a perimeter of the rod; and a coil located about the perimeter of the rod and having turns of the coil embedded with the grooves of the rod.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a perspective view of a crucible holder in accordance with an embodiment of the present invention;

FIG. 2 is a perspective view of a mold holder in accordance with an embodiment of the present invention;

FIG. 3 is a perspective view of a heating element assembly in accordance with an embodiment of the present invention;

FIG. 4 is an exploded perspective view of the heating element assembly of FIG. 3;

FIG. 5 is an exploded perspective view of a furnace having a housing and a removable heating block assembly;

FIG. 6 is a perspective view of an alternative embodiment of a furnace with heating elements and a shield located so as to protect the heating elements in accordance with an embodiment of the invention; and

FIG. 7 is an exploded view of the furnace of FIG. 6.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

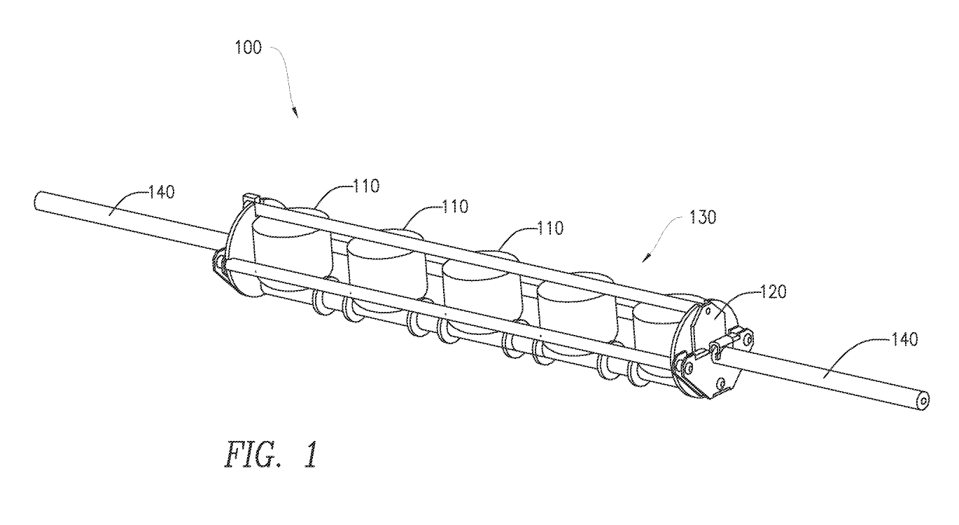

FIG. 1 is a perspective view of a crucible holder 100 useable in conjunction with an embodiment of the present invention. Crucible holder 100 may include heating element crucibles 110, brackets 120, and retaining beams 130. Crucible holder 100 is one configuration of an assembly for securing crucibles 110 within a resistive-heated furnace (furnace not shown).

In the embodiment of FIG. 1, metal (such as brackets 120) is used only at the ends of the holder central portion 130, which tends to inhibit contamination of the metal. Most of holder 100 is made of high purity ceramic, which does not oxidize or peel, and which therefore has a very low thermal expansion coefficient. The end supports 140 are made of ceramic, which is much less prone to heat sagging than metals.

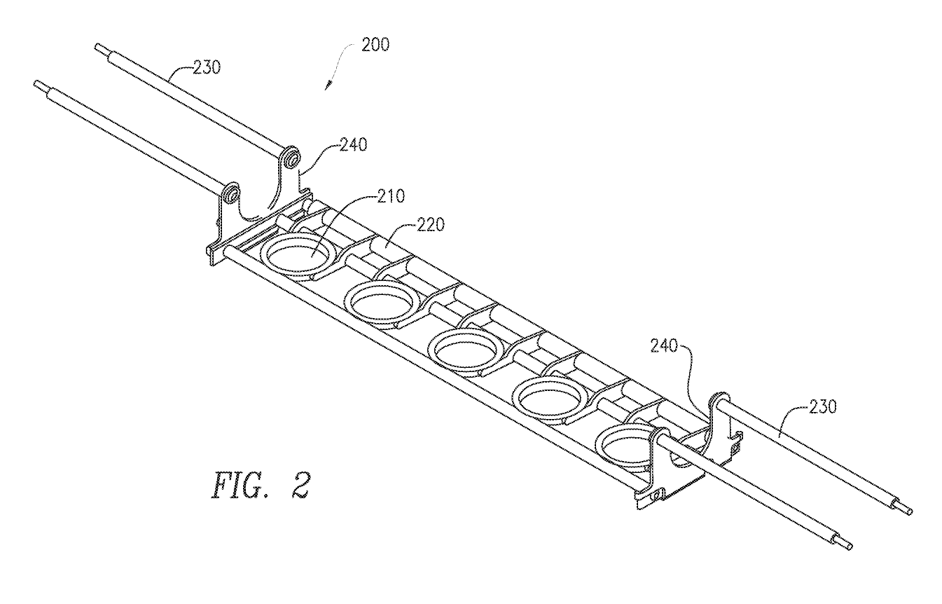

FIG. 2 is a perspective view of a mold holder assembly 200 in accordance with an embodiment of the present invention. Mold holder assembly 200 may include molds 210 and spacers 220, which may be made of ceramic.

Consistent with the goal of making mold holder 200 resilient to heat, very little metal is present in mold holder 200, thereby helping to avoid contamination, and to make for a more sag-proof assembly. End supports 230 are ceramic, and the holder central portion is freely suspended, thereby eliminating the concern for thermal expansion issues. In a preferred embodiment, brackets 240 are the only metal portion of mold holder 200. Brackets 240 may be made of a Nickel/Chrome (80/20) alloy, that is 80% nickel and 20% chrome. However, other alloys, metals, and/or alloy compositions may be employed.

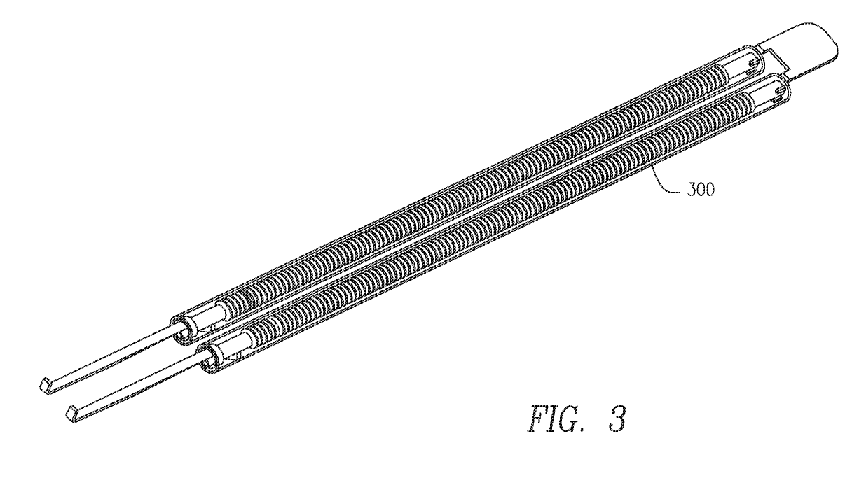

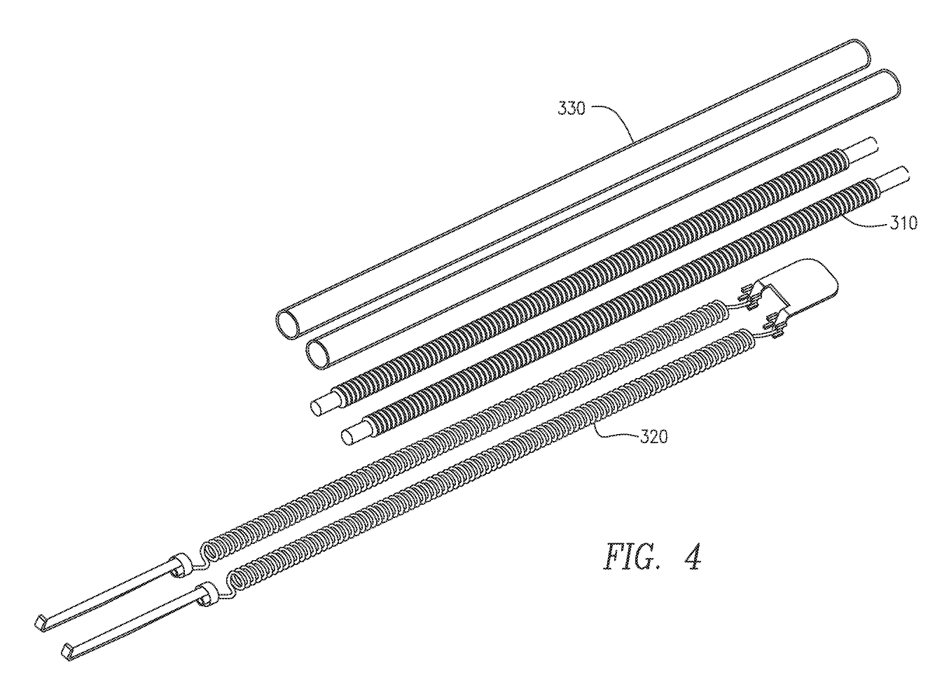

FIG. 3 is a perspective view of a heating element assembly 300 in accordance with an embodiment of the present invention. FIG. 4 is an exploded perspective view of the heating element 300 of FIG. 3.

Heating element 300 may include ceramic rod 310, coil 320, and/or shield 330. However, in some embodiments, shield 330 may not include shield 330. Rod 310 preferably includes grooves around the perimeter thereof, which are preferably in a spiral pattern. Coil 320 is preferably configured as a single helical coil having turns that match the geometry of the spiral groove in rod 310. However, the present invention is not limited the specific geometry of the spiral coil 320 and the grooves in rod 310 shown in FIG. 4, and other spiral/groove geometries may be practiced. FeCrAl is the preferred material for rod 310. However, the invention is not limited to the use of this material. Coil 320 is preferably made of metal, and at that of a conductive metal.

When coil 320 is assembled onto rod 310, the turns of coil 320 become embedded within respective grooves around the exterior of rod 310. Thus, the ridges in between the grooves of the exterior of rod 310 end up being located in between adjacent turns of the coil 320. With this arrangement, the ridges restrain any possible movement of the turns of coil 320, and thus keep adjacent turns of coil 320 properly spaced apart from one another during high temperature conditions within the furnace. Thus, even when high temperatures tend to create expansion forces within coil 320, the ridges between the grooves on the exterior of rod 310 prevent the turns of coil 320 from approaching one another. Thus, the prior-art problem of excess localized heating arising from turns of coil 320 moving toward one another under high temperature conditions is prevented by the presence of grooves and ridges on rod 310.

After coil 320 has been assembled onto rod 310, shield 330 may be slid over the combination of coil 320 and rod 310 to form heating element assembly 300, as shown in FIG. 3. Shield 330 operates to protect the coil 320 and rod 310 from flux and/or other debris that may unintentionally spill onto the rods 310 during the heating process. Shield 330 may be made of quartz, sapphire, and/or other suitable material.

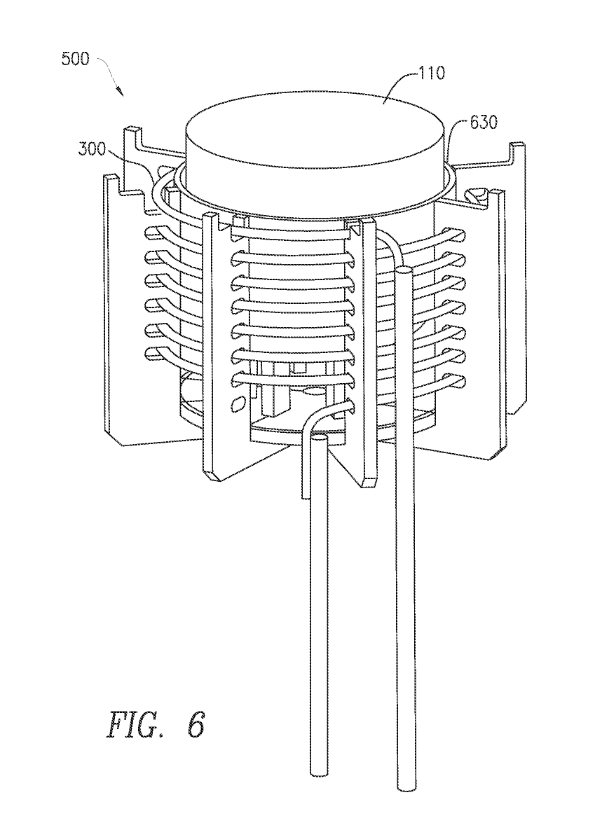

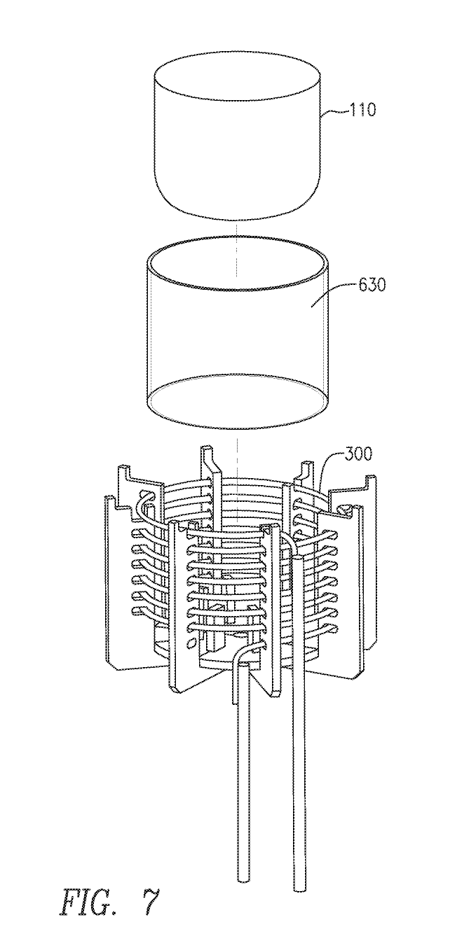

FIG. 6 is a perspective view of an alternative embodiment of a furnace 500 with heating element 300 and a shield 630 located so as to protect the heating element 300. FIG. 7 is an exploded view of the furnace of FIG. 6.

In the embodiment of FIG. 6, heating element 300 is in the form of a spiral that encircles crucible 110 several times. Shield 630 is preferably sheet of quartz, sapphire or other suitable material that is configured into the shape of a hollow cylinder, and placed radially outward from crucible 110 and radially inward of heating element 300. Placement of shield 630 in this location operates to prevent flux and other debris, which is commonly present on the exterior of crucible 110 in production situations, from reaching and inflicting damage on heating element 300.

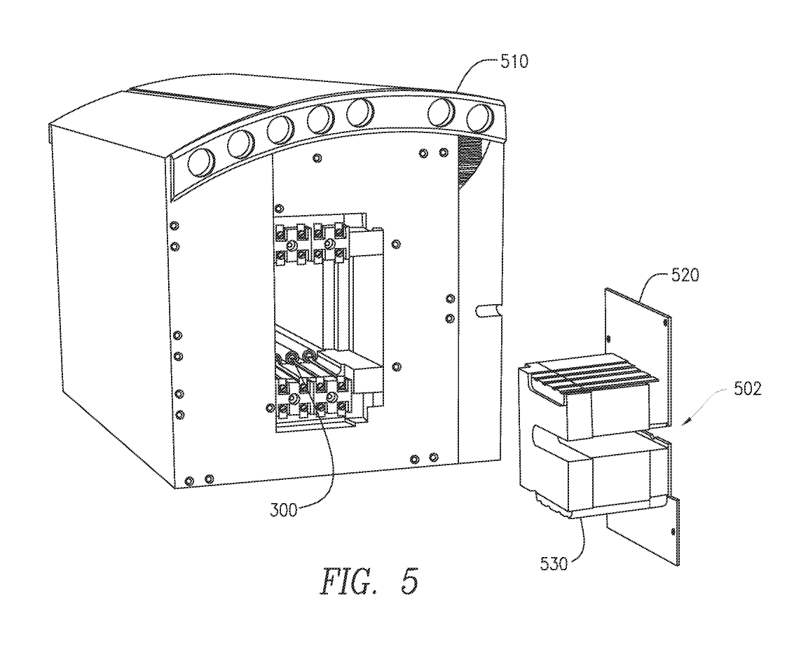

FIG. 5 is an exploded perspective view of a furnace 500 having a housing and a removable heating block assembly. Furnace 500 may include housing 510, heating element assemblies 300, and a module 502 including ceramic block 530 and panel 520, which may be metallic.

As shown in FIG. 5, the removal of module 520 provides a user with unobstructed access to heating element assemblies 300 located inside housing 510, thereby making cleaning, removal, and replacement of heating element assemblies 300 much faster, safer and easier. Once operations such cleaning and/or replacement of the heating element assemblies 300 are complete, module 502 may be readily re-attached to housing 510 to properly seal furnace 500.

The disclosed embodiment overcomes problems in the prior art that arose when users needed to extract heating elements 300 through restricted openings in housing 510 under conditions providing limited access, poor visibility, and the possibility of damaging heating element assemblies 300 upon removing same from the housing 510.

Attention is now directed to benefits observed due to some of the inventive embodiments disclosed herein. Employing the removable module, the crucible holders can be removed and disassembled in under a minute, without the use of tools. Individual parts can then be replaced or cleaned easily. The materials used for heat shield 330 operate to minimize the risk of sample contamination, and reduce the likelihood of thermal expansion and sagging. Durability is greatly improved with the inventive embodiments. As for the heating elements, life expectancy was dramatically increased, in order to minimize costly downtime in laboratories. Flux spills and halogen vapors are much less of a problem with the inventive embodiments.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A heating apparatus comprising:
a ceramic rod having at least one circumferential groove extending about a perimeter of the rod; and
a coil located about the perimeter of the rod and having a plurality of turns embedded within respective grooves of the rod.

2. The heating apparatus of claim 1 wherein the at least one groove comprises a single spiral groove encircling the perimeter of the rod; and wherein the coil has a spiral shape corresponding to the shape of the spiral groove.

3. The heating apparatus of claim 1 wherein the conductive coil is metallic.

4. The heating apparatus of claim 1 wherein ridges in between adjacent parallel groove segments are operable to maintain a minimum separation distance between adjacent parallel portions of the coil, thereby preventing local overheating of the apparatus.

5. The heating apparatus of claim 1 further comprising:
a substantially cylindrical shield disposed about the perimeter of the rod and the coil.

6. The heating apparatus of claim 5 wherein the shield is made of quartz or sapphire.

7. A furnace comprising:
a housing having an opening;
heating elements within the housing;
an interior space configured to receive items to be heated by the heating elements; and
a removable, re-attachable module configured to mate with the opening of the housing to enable user access to the interior space and to the heating elements upon removal of the module.

8. The furnace of claim 7 wherein the module comprises:
a panel suitable for attachment to the housing; and
a ceramic block coupled to the panel and configured to fill a portion of the interior space of the furnace when the module is attached to the furnace housing.

9. A heating apparatus, comprising:
a heating element;
an object for heating by the heating element
a shield located in between the heating element and the object and operable to protect the heating element from transmission of materials from the object to the heating element.

10. The heating apparatus of claim 9 wherein the heating element and the shield are substantially straight and cylindrical, and wherein the shield is a hollow cylinder and is positioned substantially concentrically with the substantially cylindrical heating element.

11. The heating apparatus of claim 10 wherein the heating element is coil shaped and includes a plurality of turns in the coil that surround the object to be heated; and
wherein the shield is a cylinder located radially outward from the object and radially inward of the turns of the coil-shaped heating element.

12. The heating apparatus of claim 11 wherein the shield is positioned so as to be substantially concentric with the object.

13. Apparatus comprising a ceramic portion for holding a plurality of molds, a metal portion for freely supporting said ceramic portion, and two ceramic end portions for maintaining said apparatus within a fusion machine.
